(19) United States
(12) Patent Application Publication
(10) Pub. No.: US 2023/0000160 A1
(43) Pub. Date: Jan. 5, 2023

(54) HEATER AND CIGARETTE DEVICE HAVING SAME

(71) Applicant: SHENZHEN FIRST UNION TECHNOLOGY CO., LTD., Shenzhen City, Guangdong Province (CN)

(72) Inventors: RUILONG HU, Shenzhen City, Guangdong Province (CN); ZHONGLI XU, Shenzhen City, Guangdong Province (CN); YONGHAI LI, Shenzhen City, Guangdong Province (CN)

(21) Appl. No.: 17/790,729

(22) PCT Filed: Dec. 30, 2020
(86) PCT No.: PCT/CN2020/141585

§ 371 Date: Jul. 2, 2022

(30) Foreign Application Priority Data
Jan. 2, 2020 (CN) 202010000296.2

(51) Int. Cl. A24F 40/46; H05B 3/00; A24F 40/20

(52) U.S. Cl. CPC A24F 40/46; H05B 3/0033; A24F 40/20; H05B 2203/016; H05B 2203/032

(57) ABSTRACT

A heater and a cigarette device containing the heater are provided. The heater includes a base. A cavity chamber is formed inside the base and is used to receive solid smoking substances. The base has an opened end and a closed end disposed opposite to each other. The solid smoking substances are received in the cavity chamber or removed from the cavity chamber through the opened end. An infrared heating assembly is used to receive electric powers of an electric power source in order to generate heat, and transmits the generated heat in at least a way of infrared radiation toward the solid smoking substances received in the cavity chamber from the closed end of the base in order to generate aerosols for inhaling. The generated aerosols are brought away by airflows passing the opened end of the base.

The present invention claims benefit of Chinese Application No. 202010000296.2, filed in Chinese Patent Office on Jan. 2, 2020 and entitled as “Heating Device and Cigarette Equipment Having the Heating Device”, the disclosure of which is incorporated by reference herein.

### FIELD OF THE INVENTION

The present invention relates to a technical field of cigarette equipment, particularly relates to a heater and a cigarette device having the heater.

### DESCRIPTION OF BACKGROUND RELATED ART

Smoking products such as cigarettes and cigars are designed to burn tobacco during their using period to generate smokes. Existing technology has already tried to manufacture products releasing chemicals in a non-burning condition for providing substitutes of the products burning tobacco. An example of such products is performed by so-called heating non-burning products. In other words, chemicals are released by heating tobacco rather than burning tobacco.

As shown in a Chinese patent application with a publishing number CN209090070U, a smoke generating device is disclosed, which comprises a ceramic-based heating element and a detachable smoking material container arranged in a casing, and the ceramic-based heating element bakes the smoking material contained in the detachable smoking material container from the bottom Heating produces smoke. Among them, the side wall and bottom of the container for accommodating the smoking material are provided with ventilation holes, and the outside air enters the container through the ventilation holes to supply the air required for heating the smoking material, so that the smoking material is heated more fully.

However, opening the ventilation holes on the container for accommodating the smoking material will easily cause the residue particles of the smoking material to fall out of the container, and the residue particles will generate peculiar smell and harmful gas after being repeatedly heated; Depending on the heating method of the element, the smoking material is not uniformly heated, and it may even occur that the outer part of the smoking material has been burnt even when the central part of the smoking material has not been roasted, thereby reducing the user experience.

### BRIEF SUMMARY OF THE INVENTION

The present invention provides a heater and a cigarette device containing the heater. They are designed to solve problem that the residual particles of the smoking material in the existing smoking device are easily dropped from the ventilation holes on the container for accommodating the smoking material, and the smoking material is heated unevenly.

In a first aspect, a heater in accordance with the present invention is provided. The heater is used to heat solid smoking substances, and aerosols are formed from volatilizing at least an ingredient of the solid smoking substances in order for inhaling of users. The heater includes the following.

A base of the heater is provided. A cavity chamber is formed inside the base and is used to receive the solid smoking substances. The base has an opened end and a closed end disposed opposite to each other. The solid smoking substances are received in the cavity chamber or removed from the cavity chamber through the opened end.

An infrared heating assembly is used to receive electric powers of an electric power source in order to generate heat, and transmits the generated heat in at least a way of infrared radiation toward the solid smoking substances received in the cavity chamber from the closed end of the base in order to generate aerosols for inhaling.

In particular, the generated aerosols are brought away by airflows passing the opened end of the base.

In a second aspect, a cigarette device in accordance with the present invention is provided. The cigarette device includes an electric power source, and the heater described in the first aspect above. The electric power source is used to provide electric powers to the heater.

The heater and the cigarette device containing the heater in accordance with the present invention are provided to heat the solid smoking substances via infrared radiation from a bottom of the base. The solid smoking substances are heated uniformly, and a temperature thereof is raised faster. On the other hand, no vent is disposed at the base. The solid smoking substances and their residues and particulates can be avoided from falling out through the vent to result in problem that peculiar odors and deleterious gases will be generated after the solid smoking substances and their residues and particulates are repeatedly heated.

### BRIEF DESCRIPTION OF THE DRAWINGS

One or more embodiments in accordance with the present invention are illustratively exemplified for explanation through figures shown in the corresponding attached drawings. These exemplified descriptions do not constitute any limitation on the embodiments. The elements with the same reference numerals in the attached drawings are denoted as similar elements. Unless otherwise stated, the figures in the attached drawings do not constitute any scale limitation.

FIG. 1 shows a schematic perspective view of a heater in accordance with a first preferred embodiment of the present invention.

FIG. 2 shows a schematic perspective view of a heater having a circular electrode and a ring-shaped electrode in accordance with a first preferred embodiment of the present invention.

FIG. 3 shows a schematic perspective view of a heater having planar spiral electrodes in accordance with a first preferred embodiment of the present invention.

FIG. 4 shows a schematic perspective view of a heater having electrodes and an infrared electric-heating layer disposed along a longitudinal direction of a base in accordance with a first preferred embodiment of the present invention.

FIG. 5 shows another schematic perspective view of a heater having electrodes and an infrared electric-heating layer disposed along a longitudinal direction of a base in accordance with a first preferred embodiment of the present invention.

FIG. 6 shows a schematic perspective view of a cigarette device in accordance with a second preferred embodiment of the present invention.

### DETAILED DESCRIPTION OF THE INVENTION

In order to facilitate best understanding of the present invention, the present invention will be illustrated in more detail below in conjunction with the attached drawings and preferred embodiments. It should be noted that when an element is expressed as “being fixed to/being fixedly connected to” another element, this element may be directly on the another element, or there may be one or more intervening elements between this element and the another element. When an element is expressed as “being connected to” another element, this element can be directly connected to the another element, or there may be one or more intervening elements between this element and the another element. Terminology used in the specification such as “upper”, “lower”, “left”, “right”, “inside”, “outside”, or similar expressions, etc., is only used for descriptive purposes.

Unless otherwise defined, any technical and scientific terminology used in this specification has the same meaning as commonly understood by those skilled in the technical field of the present invention. Terminology used in this specification of the present invention is only for a purpose of describing specific embodiments, and is not used to limit the present invention. Terminology such as “and/or” used in this specification includes any and all combinations of one or more related listed items.

### Embodiment 1

A heater 1 in accordance with a first embodiment of the present invention is provided to be used to heat solid smoking substances. Aerosols are formed from volatilizing at least an ingredient of the solid smoking substances in order for inhaling of users. The heater includes a base 11 and an infrared heating assembly.

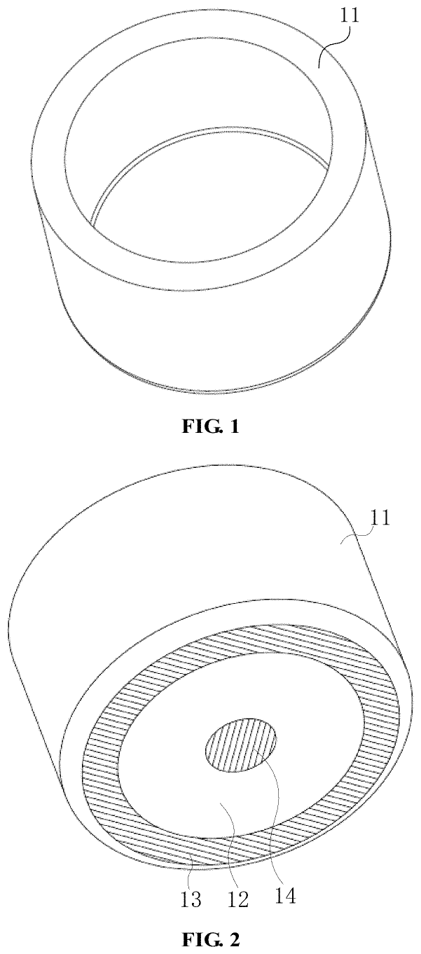

Referring to FIG. 1, a cavity chamber is formed inside the base 11 and is used to receive the solid smoking substances. The base 11 has an opened end and a closed end disposed opposite to each other. The solid smoking substances are received in the cavity chamber or removed from the cavity chamber through the opened end. The base 11 can be cylindrical, prism-shaped or other column-shaped. The base 11 is preferably cylindrical. The cavity chamber is a cylindrical hole in the base 11. The solid smoking substances can be heated when the solid smoking substances are disposed in the cavity chamber.

The base 11 can be made from high-temperature resistant and higher infrared transmittance materials. The materials include, but not limited to, the following materials such as quartz glass, sapphire, silicon carbide, magnesium fluoride ceramics, yttrium oxide ceramics, magnesium aluminum spinel ceramics, yttrium aluminum garnet monocrystal or germanium monocrystal, etc. Preferably, the base 11 is made from quartz glass.

The solid smoking substances can be solid smoking substances such as cigarettes, cut tobacco, tobacco blocks, tobacco stems and/or tobacco pastes, etc., and can also be semi-finished products or products of tobacco species, Chinese herb species, spice species, etc. Taking a solid aerosol generating substrate as an example, the aerosol generating substrate is a substrate being able to release volatile compounds forming aerosols. The volatile compounds can be released via heating the aerosol generating substrate. The aerosol generating substrate can be absorbed, coated, immersed or loaded in other ways to a carrier and a supporting piece. The aerosol generating substrate can be conveniently a part of aerosol generating products or smoking products.

The aerosol generating substrate can include nicotine. The aerosol generating substrate can include tobacco. For instance, the aerosol generating substrate can include a tobacco-contained material containing volatile tobacco favor compounds. The volatile tobacco favor compounds are released from the aerosol generating substrate when the aerosol generating substrate is heated. Preferably, the aerosol generating substrate can contain a uniform tobacco material, such as deciduous tobacco. The aerosol generating substrate can contain at least an aerosol generating agent. The aerosol generating agent can be any suitable well-known compounds or mixtures of compounds. In use, the compounds or mixtures of compounds facilitate forming of compact and steady aerosols, and basically have resistance to thermal degradation under an operation temperature of an aerosol generating system. Proper aerosol generating agents are well known in the art of the present invention, and include, but do not be limited to, polyalcohol such as triethylene glycol, 1,3-butanediol and glycerol, polyalcohol ester such as glycerol mono-, di-, or tri-acetate, and mono-, di-, or poly-carboxylic acid of fatty acid ester such as dodecanedioic acid dimethyl ester, tetradecanedioic acid, 1,14-dimethyl ester. Preferably, the aerosol generating agent is polycarboxylic alcohol or mixtures thereof, such as triethylene glycol, 1,3-butanediol, and preferably glycerine.

The infrared heating assembly is used to receive electric powers of an electric power source in order to generate heat, and transmits the generated heat in a way of infrared radiation toward the solid smoking substances received in the cavity chamber from the closed end of the base 11 in order to generate aerosols for inhaling. The generated aerosols are brought away by airflows passing the opened end of the base 11.

In the first preferred embodiment of the present invention, no vent is disposed at lateral sides of the base 11 or an end face of the closed end of the base 11. As a result, on the one hand, the solid smoking substances and their residues and particulates can be avoided from falling out through the vent to result in problem that peculiar odors and deleterious gases will be generated after the solid smoking substances and their residues and particulates are repeatedly heated. On the other hand, the solid smoking substances are heated though infrared radiation from a bottom of the base 11 so that the solid smoking substances are heated uniformly, and a temperature thereof is raised faster.

Please refer to FIG. 2. In a preferred embodiment of the present invention, the infrared heating assembly includes an infrared electric-heating layer 12, and conductors 13, 14.

The infrared electric-heating layer 12 is formed at the end face of the closed end of the base 11. The infrared electric-heating layer 12 can be formed at an inner end face or an outer end face of the closed end of the base 11, and can be formed at a part of the end face or an entire face of the end face. Preferably, the infrared electric-heating layer 12 is formed at an entire face of the outer end face of the closed end of the base 11.

In the preferred embodiment of the present invention as shown in FIG. 2, the infrared electric-heating layer 12 is preferably coated and printed on the outer end face of the closed end of the base 11 after infrared electric-heating ink, ceramic powers and inorganic adhesives are blended uniformly and stirred completely for coating, and is then baked to be dried and solidified for a certain time period. A thickness of the infrared electric-heating layer 12 is 30 μm˜50 μm. Of course, the infrared electric-heating layer 12 can further be coated to cover the outer end face of the closed end of the base 11 after tin tetrachloride, tin oxide, antimony trichloride, titanium tetrachloride and cupric sulphate anhydrous are blended based on a certain ratio and stirred for coating. Alternatively, the infrared electric-heating layer 12 is one of a silicon carbide ceramic layer, a carbon fiber composite layer, a zirconium titanium series oxide ceramic layer, a zirconium titanium series nitride ceramic layer, a zirconium titanium series boride ceramic layer, a zirconium titanium series carbide ceramic layer, a ferrous series oxide ceramic layer, a ferrous series nitride ceramic layer, a ferrous series boride ceramic layer, a ferrous series carbide ceramic layer, a rare earth series oxide ceramic layer, a rare earth series nitride ceramic layer, a rare earth series boride ceramic layer, a rare earth series carbide ceramic layer, a nickel cobalt series oxide ceramic layer, a nickel cobalt series nitride ceramic layer, a nickel cobalt series boride ceramic layer, a nickel cobalt series carbide ceramic layer, or a high silicon molecular sieve ceramic layer. The infrared electric-heating layer 12 can further be other existing material coating layers.

The conductors 13, 14 include an electrode 13 and an electrode 14 spatially disposed from each other. At least one of the electrode 13 and the electrode 14 is disposed at the end face of the closed end of the base 11. The electrode 13 and the electrode 14 are respectively partially electrically connected with the infrared electric-heating layer 12 so that electric currents can flow from one of the electrode 13 and the electrode 14 to the other of the electrode 13 and the electrode 14 through the infrared electric-heating layer 12. The infrared electric-heating layer 12 receives electric powers of the electric power source through the electrode 13 and the electrode 14 to generate heat, and transmits the generated heat in at least a way of infrared radiation toward the solid smoking substances received in the cavity chamber from the closed end of the base 11. The electrode 13 and the electrode 14 have opposite electric polarities. For example, the electrode 13 is a positive electrode, and the electrode 14 is a negative electrode. Alternatively, the electrode 13 is a negative electrode, and the electrode 14 is a positive electrode.

In the preferred embodiment of the present invention as shown in FIG. 2, the electrode 13 and the electrode 14 are respectively formed at the end face of the closed end of the base 11. The infrared electric-heating layer 12 is disposed at a part of the end face of the closed end of the base 11 between the electrode 13 and the electrode 14. The electrode 13 is disposed adjacent to a periphery of the closed end of the base 11, and the electrode 14 is disposed to cover a central position of the closed end of the base 11. Taking a cylindrical base 11 as an example, the end face of the closed end of the base 11 is circular. The electrode 13 can be a ring-shaped electrode disposed adjacent to the periphery of the closed end of the base 11. The electrode 14 can be a circular electrode disposed to cover the central position of the closed end of the base 11.

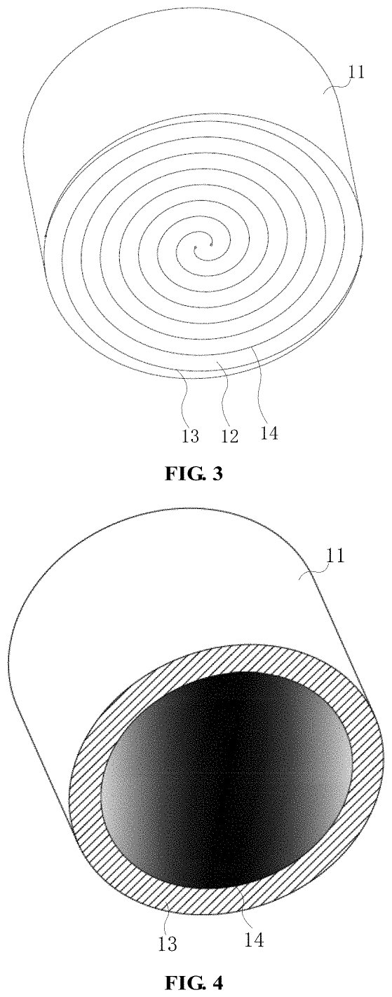

Please refer to FIG. 3. In another preferred embodiment of the present invention, the electrode 13 and the electrode 14 are respectively a planar spiral line formed by spinning around outwards from a fixed point. The fixed point is disposed adjacent to the central position of the closed end of the base 11. In particular, the fixed point is disposed at a symmetrical center by using the central position of the end face of the closed end of the base 11 as the symmetrical center. The electrodes 13, 14, which are shown in the preferred embodiment of FIG. 2, can be used to reduce an equivalent resistance of the infrared electric-heating layer 12, and to enhance an efficiency of thermoelectric conversion of the infrared electric-heating layer 12.

Furthermore, both of the electrodes 13, 14 formed by two planar spiral lines can extend to the lateral sides of the base 11 to form two lateral electrodes so that a part of each of the planar spiral lines extending to the lateral sides of the base 11 is electrically connected with the electric power source. For instance, the extending part of each of the planar spiral lines is electrically connected with a corresponding one of positive and negative terminals of the electric power source through conductive wires. Meanwhile, when the infrared electric-heating layer 12 is coated between the two formed lateral electrodes, the solid smoking substances can be heated through infrared radiation from the bottom and the lateral sides of the base 11 simultaneously. It can be easily imageable that it is also feasible when only one of the electrodes of the two formed planar spiral lines extends to the lateral sides of the base 11.

Please refer to FIG. 4. As a main difference from the preferred embodiment shown in FIG. 2, the electrode 13, the infrared electric-heating layer 12 and the electrode 14 are sequentially formed at the end face of the closed end of the base 11 along a longitudinal direction of the base 11.

In a preferred embodiment of the present invention as shown in FIG. 4, the electrode 13 covers at least a part of the outer end face of the closed end of the base 11, and the infrared electric-heating layer 12 and the electrode 14 cover a part of the electrode 13. As a result, a part of the electrode not covered by the infrared electric-heating layer 12 and the electrode 14 is used to be electrically connected with the positive terminal or the negative terminal of the electric power source.

In the preferred embodiment of the present invention as shown in FIG. 4, the electrode 13, the infrared electric-heating layer 12 and the electrode 14 can be respectively a continuous film layer. For instance, the electrode 13 and the electrode 14 are respectively a planar electrode. The electrode 13 cover at least a part of the outer end face of the closed end of the base 11, and the infrared electric-heating layer 12 and the electrode 14 cover a part of the electrode 13. Alternatively, the electrode 13 is a non-continuous film layer. For instance, the electrode 13 is a mesh electrode. A shape of mesh apertures of the mesh electrode is a rhombus, a square, a circle, a triangle or an irregular shape, etc.

In the preferred embodiment of the present invention as shown in FIG. 4, in comparison with the preferred embodiment of the present invention as shown in FIG. 2, an electrically conductive sectional area of the infrared electric-heating layer 12 is significantly enlarged. The infrared electric-heating layer 12 can be selectively made from materials having higher electric resistivity. Examples of such materials are as follows. In particular, examples are provided as follows.

The infrared electric-heating layer 12 can be selectively made from materials having a higher infrared radiance, such as oxides, carbon materials, carbides or nitrides, etc.

Metal oxides and multicomponent alloy oxides include ferric sesquioxide, aluminum sesquioxide, chromic sesquioxide, indium sesquioxide, lanthanum sesquioxide, cobalt sesquioxide, nickel sesquioxide, antimony sesquioxide, diantimony pentoxide, titanium dioxide, zirconium dioxide, manganese dioxide, cerium dioxide, copper oxide, zinc oxide, magnesium oxide, calcium oxide or molybdenum trioxide, etc. They can also be a compound of two kinds or more than two kinds of metal oxides, and can further be ceramic materials with a unit cell structure such as spinel, perovskite or olivine, etc.

Carbon materials have an emissivity close to a characteristic of black body, and have a higher infrared radiance. The carbon materials include graphite, carbon fiber, carbon nanotube, graphene or diamond-like carbon film, etc.

Carbides include silicon carbide. Silicon carbide has a high emissivity within a larger infrared wavelength range (2.3 μm˜25 μm), and is a better material for an almost full-wave band of infrared radiation. In addition, carbides further include tungsten carbide, ferric carbide, vanadium carbide, titanium carbide, zirconium carbide, manganese carbide, chromium carbide or niobium carbide, etc. All of them have a higher infrared emissivity (MeC, an expression for metal carbide without using rigorous chemical calculating composition or chemical formula

Nitrides include metal nitrides and nonmetal nitrides. Metal nitrides include titanium nitride, titanium carbonitride, aluminum nitride, magnesium nitride, tantalum nitride or vanadium nitride, etc. Nonmetal nitrides include boron nitride, triphosphorus pentanitride or silicon nitride (Si₃N₄), etc.

Other inorganic nonmetal materials include silicon dioxide, silicate (including phosphorus silicate, boron silicate, etc.), titanate, aluminate, phosphate, boride or chalcogenide, etc.

The infrared electric-heating layer 12 can be formed at an outer surface of the closed end of the base 11 through a physical vapor deposition process, a chemical vapor deposition process or a spraying coating process. Preferably, the infrared electric-heating layer 12 is deposited at the outer surface of the closed end of the base 11 through the physical vapor deposition process.

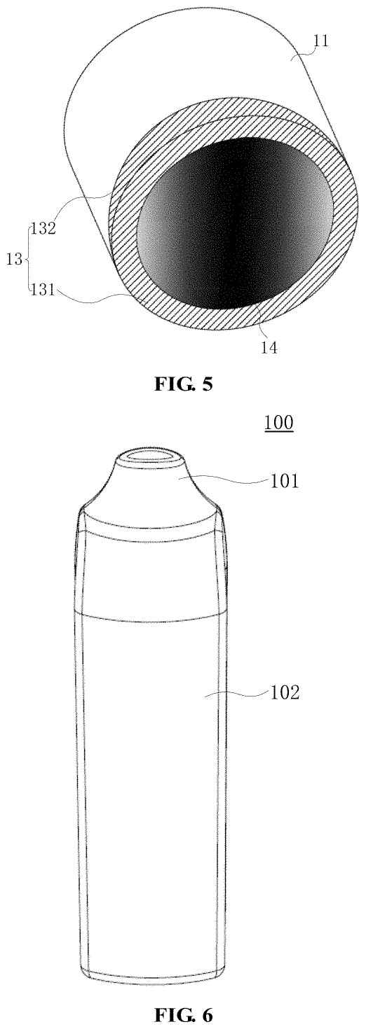

Please refer to FIG. 5. As a main difference from the preferred embodiment shown in FIG. 5, the electrode 13 covers at least a part of the outer end face of the closed end of the base 11 (as shown as indication of the reference number “131” in FIG. 5), and extends to the lateral sides of the base 11 along the outer end face of the closed end of the base 11 (as shown as indication of the reference number “132” in FIG. 5). As a result, the part 132 of the first electrode 13 extending to the lateral sides of the base 11 is electrically connected with the positive terminal or the negative terminal of the electric power source.

In a preferred embodiment of the present invention, the heater further includes an infrared reflective coating layer formed at the lateral sides of the base 11 in order to be used to reflect infrareds transmitting through the lateral sides of the base 11.

In the preferred embodiment of the present invention, when infrareds generated from the infrared electric-heating layer 12 heats the solid smoking substances via radiation through the opened end of the base 11, a part of the infrareds may transmit outsides through the lateral sides of the base 11. A function of the infrared reflective coating layer is to reflect infrareds transmitting through the lateral sides of the base 11 back to an inside of the base 11 for heating the solid smoking substances disposed in the base 11. As a result, on the one hand, an effective usage rate of infrareds emitted from the infrared electric-heating layer 12 can be enhanced. On the other hand, heat can be avoided from being thermally conducted from the lateral sides of the base 11 along a direction pointing away from the lateral sides of the base 11.

In the preferred embodiment of the present invention, the infrared reflective coating layer includes at least one kind of metals and metal oxides. In particular, the infrared reflective coating layer can be made from one kind or multiple kinds of the metals and metal oxides including gold, silver, nickel, aluminum, gold alloy, silver alloy, nickel alloy, aluminum alloy, auric oxide, silver oxide, nickel oxide, aluminum oxide, titanium dioxide, zinc oxide and cerium dioxide. A thickness of the infrared reflective coating layer is between 0.3 μm˜200 μm.

In another preferred embodiment of the present invention, the heater further includes a thermal insulative film layer formed at the lateral sides of the base 11. The thermal insulative film layer is used to at least partially prevent heat from being thermally conducted from the lateral sides of the base 11 along the direction pointing away from the lateral sides of the base 11.

In the another preferred embodiment of the present invention, a coefficient of heat conductivity of the thermal insulative film layer is smaller than 0.2 W/(m·K), preferably is smaller than 0.1 W/(m·K), much preferably is smaller than 0.05 W/(m·K), and further preferably is in a range of 0.02˜0.04 W/(m·K).

In the another preferred embodiment of the present invention, the thermal insulative film layer includes thermal insulative materials. The thermal insulative materials can be heat insulation glue, aerogel, aerogel blanket, asbestos, aluminum silicate, calcium silicate, diatomite or zirconium oxide, etc.

### Embodiment 2

Referring to FIG. 6, a cigarette device 100 in accordance with a second embodiment of the present invention is shown. The cigarette device 100 includes an inhaling nozzle 101, a housing 102, the heater as above described in the first preferred embodiment of the present invention, and an electric power source.

The inhaling nozzle 101 includes a nozzle end and an open end. The open end is detachably connected with an end of the housing 102. A vent is disposed at the nozzle end.

A plurality of air inlets are opened and disposed at a lateral wall of the housing 102. Airflows flow into the housing 102 through the plurality of air inlets. When the airflows pass the opened end of the base 11 of the heater, aerosols generated by the heater are brought away by the passing airflows, and then flow outsides through the vent of the nozzle end. A charging socket is formed at a bottom wall of the housing 102. The cigarette device 100 can be electrically charged or software upgraded through the charging socket in order to ensure long-termed continuing use of the cigarette device 100. A switch button and an indicating light are disposed at a rear wall of the housing 102. The switch button is used to switch on or switch off the cigarette device 100. The indicating light is used to indicate status information of the cigarette device 100. For instance, the status information includes a working status of the cigarette device 100, an electric quantity of a battery, etc.

A detailed structure of the heater can be referred to the above depicted content for the first preferred embodiment of the present invention, and such content is not repeated herein. The heater is disposed in an end of the housing 102 close to the inhaling nozzle 101.

The electric power source is disposed in an end of the housing 102 spaced away from inhaling nozzle 101. The electric power source includes a control circuit and a battery. The battery is electrically connected with the control circuit.

The cigarette device 100 further includes a temperature sensor. For instance, an NTC temperature sensor is used to sense a real-time temperature of the base 11, and to transmit the sensed real-time temperature to the control circuit. The control circuit adjusts an amount of electric currents passing through the infrared electric-heating layer 12 according to the sensed real-time temperature. In particular, when the NTC temperature sensor detects a lower real-time temperature in the base 11, for example, the NTC temperature sensor detects a temperature inside the base 11 being less than 150° C., the control circuit controls the battery to output a higher electric voltage to the electrodes 13, 14 in order to raise electric currents fed in the infrared electric-heating layer 12, and to raise a heating power onto the solid smoking substances for reducing a waiting time of a user inhaling a first puff. When the NTC temperature sensor detects a temperature of the base 11 being 150° C.˜200° C., the control circuit controls the battery to output a normal electric voltage to the electrodes 13, 14. When the NTC temperature sensor detects a temperature of the base 11 being 200° C.˜250° C., the control circuit controls the battery to output a lower electric voltage to the electrodes 13, 14. When the NTC temperature sensor detects a temperature inside the base 11 being 250° C. or more than 250° C., the control circuit controls the battery to stop outputting any electric voltage to the electrodes 13, 14.

It should be noted that the specification of the present invention and its accompanying drawings provides preferred embodiments of the present invention. However, the present invention can be implemented in many different forms and is not limited to the preferred embodiments described in this specification. These preferred embodiments are not intended to make additional restrictions on the content of the present invention, and the purpose of providing the preferred embodiments is to make understanding of the disclosure of the present invention become more thorough and comprehensive. In addition, the above technical features continue to be combined with one another to form various embodiments not listed above, the combinations are all regarded as being within the scope of the descriptions of the present invention. Furthermore, for those of ordinary skill in the art, improvements or transformations can be made based on the above descriptions, and all these improvements and transformations should belong to the protection scope of the appended claims of the present invention.

1. A heater, used to heat solid smoking substances, and volatilizing at least an ingredient of the solid smoking substances to form aerosols for inhaling of users, comprising:
a base, a cavity chamber being formed inside the base and used to receive the solid smoking substances therein, the base comprising an opened end and a closed end disposed opposite to each other, the solid smoking substances being received in the cavity chamber or removed from the cavity chamber through the opened end; and
an infrared heating assembly, used to receive electric powers of an electric power source to generate heat, and transmitting the generated heat in at least a way of infrared radiation toward the solid smoking substances received in the cavity chamber from the closed end of the base in order to generate aerosols for inhaling;
wherein the generated aerosols are brought away by airflows passing the opened end of the base.

2. The heater as claimed in claim 1, wherein the infrared heating assembly comprises:
an infrared electric-heating layer, comprising at least a part thereof formed at an end face of the closed end of the base; and
conductors, comprising a first electrode and a second electrode spatially disposed from each other, wherein the first electrode and the second electrode are respectively electrically connected with a corresponding one of positive and negative terminals of the electric power source in order to feed the electric powers of the electric power source to infrared electric-heating layer;
wherein at least one of the first electrode and the second electrode is disposed at the end face of the closed end of the base.

3. The heater as claimed in claim 2, wherein the first electrode and the second electrode are disposed at the end face of the closed end of the base, the infrared electric-heating layer is disposed between the first electrode and the second electrode.

4. The heater as claimed in claim 3, wherein the first electrode is disposed to cover a central position of the closed end of the base, and the second electrode is disposed adjacent to a periphery of the closed end of the base.

5. The heater as claimed in claim 4, wherein the end face of the closed end of the base is circular, the first electrode is a circular electrode disposed to cover a circle center of the closed end of the base, the second electrode is a ring-shaped electrode disposed adjacent to the periphery of the closed end of the base.

6. The heater as claimed in claim 3, wherein the first electrode and the second electrode are respectively a planar spiral line formed by spinning around outwards from a fixed point.

7. The heater as claimed in claim 6, wherein the fixed point is disposed at a symmetrical center by using a central position of the end face of the closed end of the base as the symmetrical center.

8. The heater as claimed in claim 6, wherein the planar spiral line extends to a lateral side of the base so that a part of the planar spiral line extending to the lateral side of the base is electrically connected with the electric power source.

9. The heater as claimed in claim 2, wherein the first electrode, the infrared electric-heating layer and the second electrode are sequentially formed at the end face of the closed end of the base along a longitudinal direction of the base.

10. The heater as claimed in claim 9, wherein the first electrode covers at least a part of the end face of the closed end of the base;
the infrared electric-heating layer and the second electrode cover a part of the first electrode so that a part of the first electrode not covered by the infrared electric-heating layer and the second electrode is used to be electrically connected with the positive terminal or the negative terminal of the electric power source.

11. The heater as claimed in claim 9, wherein the first electrode covers at least a part of the end face of the closed end of the base, and extends to a lateral side of the base along the end face of the closed end of the base, the part of the first electrode extending to the lateral side of the base is electrically connected with the positive terminal or the negative terminal of the electric power source;
the infrared electric-heating layer and the second electrode cover a part of the first electrode.

12. The heater as claimed in claim 9, wherein the first electrode and the second electrode are respectively a continuous film layer.

13. The heater as claimed in claim 9, wherein the first electrode is a non-continuous film layer.

14. The heater as claimed in claim 1, wherein the heater further comprises an infrared reflective coating layer formed at a lateral side of the base in order to be used to reflect infrareds transmitting through the lateral side of the base.

15. The heater as claimed in claim 14, wherein the infrared reflective coating layer comprises at least one kind of metals and metal oxides.

16. The heater as claimed in claim 1, wherein the heater further comprises a thermal insulative film layer formed at a lateral side of the base, the thermal insulative film layer is used to at least partially prevent heat from being thermally conducted from the lateral side of the base along a direction pointing away from the lateral side of the base.

17. The heater as claimed in claim 16, wherein a coefficient of heat conductivity of the thermal insulative film layer is smaller than 0.2 W/(m·K).

18. A cigarette device, wherein the cigarette device comprises an electric power source, and the heater as claimed in claim 1; the heater electric power source is used to supply electric powers to the heater.
